(19) United States
(12) Patent Application Publication
(10) Pub. No.: US 2018/0150846 A1
(43) Pub. Date: May 31, 2018

(54) SYSTEM AND METHOD FOR UTILIZING BIOMETRIC DATA IN A PAYMENT TRANSACTION

(71) Applicant: MasterCard Asia/Pacific Pte. Ltd., Singapore (SG)

(72) Inventors: Rajat Maheshwari, Singapore (SG); Philip Wei Ping Yen, Singapore (SG)

(21) Appl. No.: 15/812,088

(22) Filed: Nov. 14, 2017

(30) Foreign Application Priority Data
Nov. 29, 2016 (SG) 10201610030U

(51) Int. Cl. G06Q 20/40; G06Q 20/32; G06Q 20/20; G06Q 30/06

(52) U.S. Cl. CPC G06Q 20/40145; G06Q 20/3278; G06Q 30/06; G06Q 20/322; G06Q 20/206

(57) ABSTRACT

There is provided a system and method for utilizing biometric data in a payment transaction. The system and method relies on a transaction request message to initiate payment authorisation.

### FIELD OF THE INVENTION

The present invention relates to electronic payments between a consumer and a merchant and in particular to a method and system for utilizing biometric data in a payment transaction.

### BACKGROUND

Payment transactions that occur at a point of sale (POS) location or in an online environment typically require a consumer to pay for goods and/or services using cash or by a payment card such as a credit, debit or gift card. In the case of payment by card, a physical card is required to be presented to a merchant POS machine which is capable of receiving electronic data associated with a financial account linked to the card in order to effect payment for the goods or services.

POS machines may acquire the card information in a number of different ways. In one example, the card information is stored in a magnetic stripe which is transferred to the POS machine by swiping the card past a magnetic reading head. Other types of payment cards contain an electronic chip (known as EMV (Europay, Mastercard, Visa) cards) which are physically coupled to a chip reader of the POS machine in order to effect payment. EMV cards are typically considered more secure than magnetic stripe cards because every time they are used for payment, the card chip creates a unique transaction code that cannot be used again unlike magnetic stripes that contain unchanging data. Finally, some payment cards or some payment-enabled devices having a non-card form factor such as, for example, mobile phones, wearable devices, key fobs and the like permit contactless payment with a POS machine by using radio-frequency identification (RFID) or near field communication (NFC) technologies. Contactless payment may enable transactions to be processed faster as the consumer is usually able to pay for goods or services under a certain value without traditional methods of verification such as providing a PIN number or signature.

In addition, payment transactions can also be carried out using data processing devices such as, for example, smartphones, tablets, laptops and so forth, using a digital wallet application running on the data processing devices. The digital wallet application is associated with at least one payment card such as a credit, debit or gift card, and correspondingly, is able to provide a financial account linked to the card in order to effect payment for the goods or services. Furthermore, it should be appreciated that the data processing devices which have NFC functionalities also can be used for contactless payment with a POS machine when the digital wallet application is running on the data processing devices.

The problem with the above methods of payment is that there are ways to circumvent existing measures and carry out payment transactions. For example, it is possible to effect a payment transaction by forging a signature, unauthorised use of a PIN number, unauthorised use of the data processing device, and so forth.

The risks of unauthorised payment transactions being carried out are a concern to both users and issuers. Such risks are typically undesirable for the user as a convenience of carrying out payment is adversely affected, and for the issuer as there may be costly fraudulent transactions.

It is generally desirable to improve consumer experiences with making payments for goods and services. It is against this background, and the problems and difficulties associated therewith, that the present invention has been developed.

### SUMMARY

In a first aspect, there is provided a system for utilizing biometric data in a payment transaction. The system includes one or more electronic devices that: initiate, at a payment acceptance device, a transaction request; request, from a user payment device and/or the payment acceptance device, user account information and user biometric information, the user biometric information including data relating to at least one biometric verification method; generate, from the payment acceptance device, a transaction request message including the user account information and the user biometric information; and initiate, at a payment processing system, payment authorization using the transaction request message.

There is also provided a method for utilizing biometric data in a payment transaction, the method including, in one or more electronic processing devices: initiating, at a payment acceptance device, a transaction request; requesting, from a user payment device and/or the payment acceptance device, user account information and user biometric information, the user biometric information including data relating to at least one biometric verification method; generating, from the payment acceptance device, a transaction request message including the user account information and the user biometric information; and initiating, at a payment processing system, payment authorization using the transaction request message.

Finally, there is provided a non-transitory computer readable storage medium embodying thereon a program of computer readable instructions which, when executed by one or more processors of a payment acceptance device in communication with at least one other server, cause the payment acceptance device to carry out a method for utilizing biometric data in a payment transaction, the method embodying the steps of: initiating, a transaction request; retrieving, user account information and user biometric information, the user biometric information including data relating to at least one biometric verification method; and generating, a transaction request message including the user account information and the user biometric information. It is preferable that payment authorization is initiated using the transaction request message.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

A non-limiting example of the present invention will now be described with reference to the accompanying drawings, in which:

FIG. 1 is a flow chart of an example of a method of utilizing biometric data in a payment transaction;

FIG. 2 is a schematic diagram of an example of a system for utilizing biometric data in a payment transaction;

FIG. 3 is a schematic diagram showing components of an example point of sale (POS) device of the system shown in FIG. 2;

FIG. 4 is a schematic diagram showing components of an example user device of the system shown in FIG. 2;

FIG. 5 is a schematic diagram showing components of an example server shown in FIG. 2;

FIG. 6 is a schematic diagram showing components of an example payment system shown in FIG. 2;

FIGS. 7A and 7B are flowcharts of a specific example of a method of utilizing biometric data in a payment transaction using a POS device; and,

FIGS. 8A and 8B are flowcharts of a specific example of a method of utilizing biometric data in a payment transaction using a user device.

### DETAILED DESCRIPTION

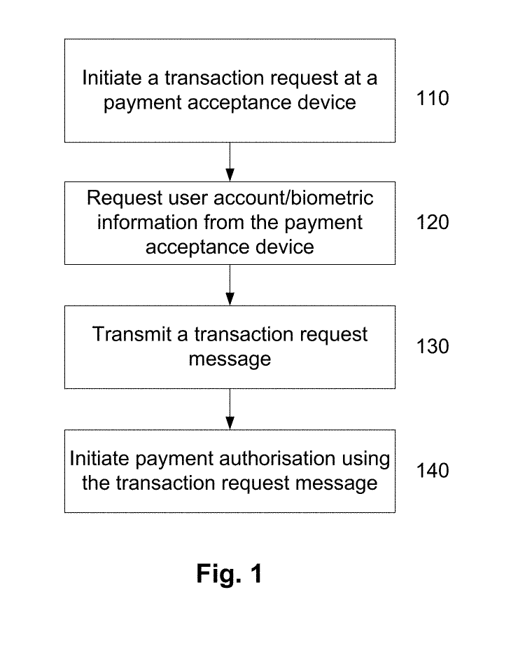

An example of a method of utilizing biometric information in a payment transaction will now be described with reference to FIG. 1.

For the purpose of illustration, it is assumed that the method is performed at least in part using one or more electronic processing devices forming part of a point of sale (POS) device in communication with one or more user devices, such as mobile phones, portable computers, tablet computers, or the like. The POS device is typically also in communication with a payment processing system which may include a number of processing devices associated with each of an issuer, acquirer, card network and payment gateway, or alternatively, the payment processing system may be any one or more of these entities and this will be discussed further below.

In this example, at step 110 the one or more electronic processing devices initiate a transaction request at a payment acceptance device. The payment acceptance device receives payment credentials (such as a primary account number (PAN) or a token representative of a PAN) from a user payment device in order to transmit those credentials, together with other transaction-related information, to a payment network for processing. The payment acceptance device can be, for example, a card acceptance device such as a POS device. The POS device may be capable of accepting payment credentials in contactless fashion, for example from a payment card or mobile device according to the EMV Contactless Specification, or from a mobile device in a contactless magnetic stripe transaction by magnetic secure transmission (MST) technology.

The user payment device can be, for example, a user device, a user payment card and so forth.

At step 120, the one or more electronic processing devices then requests user account information and user biometric information from the user payment device and/or the payment acceptance device. The request for account information can be provided in any suitable manner. For example, a POS device may obtain the account information from a payment card coupled to the POS device. Alternatively, if the user has a digital wallet application installed on their user device, the POS device may send a pull message to the user device requesting access to the digital wallet application which stores user account details such as credit card information and the like. Whilst any type of wallet application may be used, such as MasterPass™, Apple™ Pay, Google™ Wallet, or the like, in some instances the application is provided by a user's banking institution.

In one example, the user may allow the POS device access to the account information and user biometric information stored in their digital wallet application by authenticating the request with appropriate verification information such as a PIN number or biometric information associated with the digital wallet application. If instead the user has been prompted to supply account information via a payment page or the like displayed on their device, then the POS device may receive the user account information as a result of the user manually entering their bank account or card details in the payment UI. In another example, the POS device accesses the account information and user biometric information stored on a payment card coupled to the POS device. In another example, the POS device obtains the account information stored on a payment card coupled to the POS device, and the POS device can be configured to capture the user biometric information with requisite sensors of the POS device. In a further example, the user device is configured to capture the user biometric information with requisite sensors of the user device. The user biometric information can include, for example, fingerprint data, iris data, facial features data, pulse rate data, voice data, retina data, ear cavity echo data, vein pattern data, speech pattern data and so forth. The user biometric information can be captured at a single juncture, over a pre-determined period of time, or in perpetuity.

At step 130, the one or more electronic processing devices transmit a transaction request message, the transaction request message including both the user account information and the user biometric information. The user biometric information can comprise data indicative of whether a best available biometric information match was used in said at least one biometric verification method. The transaction request message can be an ISO 8583 formatted message and the user biometric information can be encoded in DE55 or DE48 when the transaction request message is an EMV transaction request message, or is encoded in track data when the transaction request message is a contactless magnetic stripe transaction request message.

After receiving the transaction request message, at step 140 the one or more electronic processing devices initiate payment authorization with a payment processing system, using the user account information and the user biometric information to enable the payment transaction to be performed. As previously mentioned, the payment processing system may include a number of processing systems associated with each of an issuer, acquirer, card network.

In one example as will be well understood in the art, the payment acceptance device sends a transaction request message comprising the user account information, and user biometric information, to a merchant's acquirer. The user biometric information comprises data indicative of results of at least one biometric verification process. The at least one biometric verification process can be carried out on the user device, on the payment acceptance device (or biometric sensor(s) coupled thereto), or both. For example, an iris verification may be carried out on the user device, while a subsequent fingerprint verification is carried out on the payment acceptance device or a fingerprint reader coupled to the payment acceptance device. In alternative embodiments, some or all of the biometric verification may be delegated to a separate device, such as a biometric verification server located remotely from the user device and the payment acceptance device. The biometric verification server may be a server operated by the issuer of the user payment device (or a payment instrument which is stored in digitised form on the user payment device).

The acquirer then requests that the card network get an authorization from the user's issuing bank. It should be appreciated that authorisation includes verification of the user's biometric information. The card network submits the transaction to the issuer for authorization and the issuing bank then authorizes the transaction if the account has sufficient funds to cover the amount payable. The issuer then routes payment to the acquirer who then deposits the payment into the merchant's account.

The data indicative of results of at least one biometric verification process may comprise the following:

a. Biometrics matching (e.g., 2 bits)
i. Whether the match was being carried out on a remote server;
ii. Whether the match was being carried out on a mobile device;
iii. Whether the match was being carried out on a biometric card (i.e., a card having at least one biometric sensor);
iv. Whether the match was being carried out on a payment terminal.

b. Biometrics template stored (e.g., 2 bits)
i. Whether the template/image (to which user biometric data was matched) is being stored on device;
ii. Whether the template/image is being stored on server;
iii. Whether the template/image is being stored on a biometric card.

c. Best available match used (e.g., 1 bit)
i. Whether multiple fingerprints or both irises are registered, and if the best matching biometric (e.g., best available fingerprint) was used.

d. Rating of the authentication mechanism for device/card (2 bits)
i. Whether the sensor/device has been approved by an approval authority (e.g. issuer, payment network such as Mastercard™, or third party device approver) (False Match Rate/False Negative Match Rate figures meeting requirements);
ii. Whether the sensor/device has not been approved by the approval authority (FMR/FNMR figures not meeting requirements);
iii. Whether only security evaluation done, no functional evaluation performed;
iv. Where no evaluation is performed.

The abovementioned example therefore provides a method of utilizing biometric data in a payment transaction. The transaction is facilitated by one or more processing devices, which optionally form part of a physically distinct POS device, which may be separate to a POS terminal. The POS device can provide the necessary connectivity to allow interaction with a user device and other systems as required, allowing users to perform transactions using their own user device. The transaction can also be facilitated by one or more processing devices, which form part of a user device.

Accordingly, the above described method provides a number of advantages.

The present invention provides for the use of the user biometric information to aid in the approval of a transaction. For example, open operating systems like Android provides a framework for biometrics verification, but lack restrictions on false acceptance rate/false rejection rate/minimum expected matching score. In this regard, consumers are at risk as they rely on primarily vendor implementation/algorithm of biometric verification. The present invention provides a consistent level for biometric verification for consumers as it is administered by a single entity, and correspondingly, this consistency can assist in determining a risk score for consumers and the authorisation process (possibly reducing transaction declines) and the use of biometric verification can also aid in fraud detection/prevention.

In addition, by being provided with data indicative of results of at least one biometric verification process, such as the data mentioned in the examples above, as part of a transaction request message, the party responsible for approving or declining the transaction (typically, the issuer, or a delegate of the issuer such as a transaction processing service provider) is able to implement more nuanced risk management logic. For example, the risk management logic may be modified for a high-value transaction to take into account that the best available match was used such that a higher degree of confidence is associated with the transaction, so that the transaction can be approved when it might otherwise have been declined. This may help to reduce network traffic since there is a reduced rate of additional authorisation requests required following false declines. Additionally, since the biometric results data may be encoded in standard format transaction messages (such as ISO 8583 formatted messages), this additional information can be transmitted over standard payments infrastructure without significant modification to acquirer or issuer processing systems or to payment network servers.

A number of further features will now be described.

In order to further enhance security, communication with the payment acceptance device may be encrypted. In one example, the digital wallet application installed on the user device may have embedded encryption that can only be decrypted by the payment acceptance device. In this way, user account information and user biometric information received by the payment acceptance device may be routed securely over the network and interpreted only by the payment acceptance device for use in initiating payment authorisation with the payment processing system. Furthermore, each user device can be assessed in relation to functionality and security in order to determine a device certification. For example, if a device is assessed favourably for both functionality and security, the device is given a more desirable certification compared to a device that is only assessed favourably for functionality. In this regard, a user who uses the device that is assessed more favourably is likely to experience fewer failed transactions compared to a user who uses the device that is assessed less favourably.

In one example, the one or more electronic processing devices may send a request to the user device to access a digital wallet application installed on the user device in order to retrieve user account information, the user device being responsive to the request to selectively provide user account information to the one or more electronic processing devices. The electronic processing devices may then receive user account information from the user device. Typically, the digital wallet application is configured to verify the user, possibly using biometric information, to selectively provide the user account information.

In this regard, the digital wallet application may prompt the user to provide verification information, selectively authenticate the user using the verification information and provide access to the user account information in response to successful verification. Typically, the verification information includes a PIN number associated with the digital wallet application, however any form of verification information may be used including biometric information such as finger prints, a voice print, or an image of the user captured by the user device (e.g. triggered by a facial gesture of the user, such as by the user blinking). The user provides their PIN number to the digital wallet application which verifies the PIN typically at a remote server where the user security details are stored. If the PIN is verified as correct, the user is authenticated as being the owner of the digital wallet application and in response the digital wallet application provides the user account details to the POS device so that the payment authorization process can be initiated.

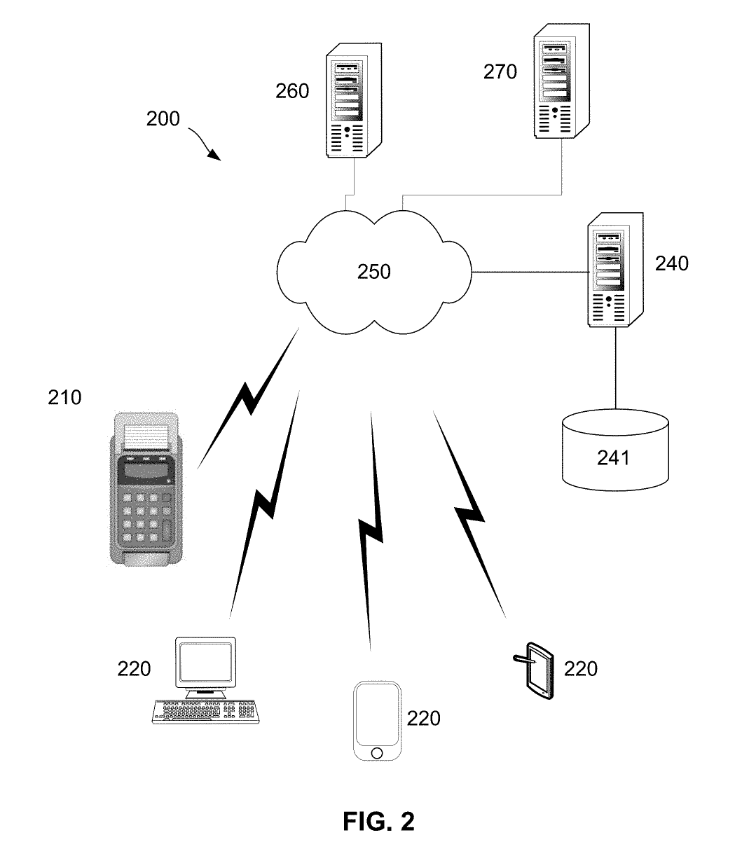

An example of a system for utilizing biometric data in a payment transaction will now be described with reference to FIG. 2.

In this example, the system 200 includes a POS electronic processing device 210, one or more user devices 220 running a payment application such as a digital wallet application and optionally a merchant application, a communications network 250, an issuer server 260, an acquirer server 270 and a payment processing device 240 in communication with a database 241.

The communications network 250 can be of any appropriate form, such as the Internet and/or a number of local area networks (LANs) It will be appreciated that the configuration shown in FIG. 2 is for the purpose of example only, and in practice the user devices 220, POS device 210, issuer server 260, acquirer server 270 and payment processing device 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the one or more user devices 220 can communicate with the POS device 210 via a wireless communication protocol such as Wi-Fi or Bluetooth but not limited to such. In one example, the POS device 210 includes a wireless router and provides a wireless network (e.g. Wi-Fi) to which the one or more user devices 220 are able to connect. Alternatively, the POS device 210 may be connected to a wireless network provided by a merchant to which the one or more user devices 220 may connect in order to communicate with the POS device 210.

### POS Device 210

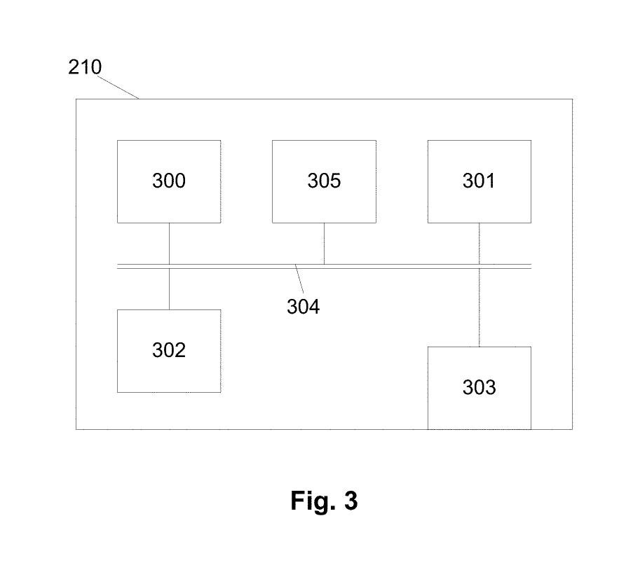

A suitable POS device 210 for use in the system for performing a POS payment transaction described in any of the above examples is shown in FIG. 3.

In this example, the POS device 210 includes at least one microprocessor 300, a memory 301, an optional input/output device 302, such as a display, keyboard, touchscreen and the like, a biometric information sensor 305, and an external interface 303, interconnected via a bus 304 as shown. The biometric information sensor 305 can be configured to capture biometric information such as, for example, fingerprint, iris, facial features, pulse rate, voice, retina, ear canal, vein, speech pattern and the like. In this example the external interface 303 can be utilised by the POS device 210 when communicating with peripheral devices, such as the user device 220, communications networks, payment processing device 240, merchant server 230, issuer server 260, acquirer server 270, databases, other storage devices, or the like. Although only a single interface 303 is shown, this is for the purpose of example only, and in practice multiple interfaces using various methods (e.g. Ethernet, serial, USB, wireless, Bluetooth™ Low Energy (BLE), Near Field Communication (NFC), or the like) may be provided.

In use, the microprocessor 300 executes instructions in the form of applications software stored in the memory 301 to allow communication with the user device 220, for example to receive a transaction request, the merchant processing device 240, for example to receive payment information, the issuer server 260, for example to receive authorisation information and the payment processing device 230, for example to initiate payment authorization. The applications software may include one or more software modules, and may be executed in a suitable execution environment, such as an operating system environment, or the like.

Accordingly, it will be appreciated that the POS device 210 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the POS device 210 may also be formed from a suitably programmed PC, Internet terminal, lap-top, or hand-held PC, a tablet, or smart phone, or the like. Thus, in one example, the processing system 210 is a standard processing system such as an Intel Architecture based processing system, which executes software applications stored on non-volatile (e.g., hard disk) storage, although this is not essential.

### User Device 220

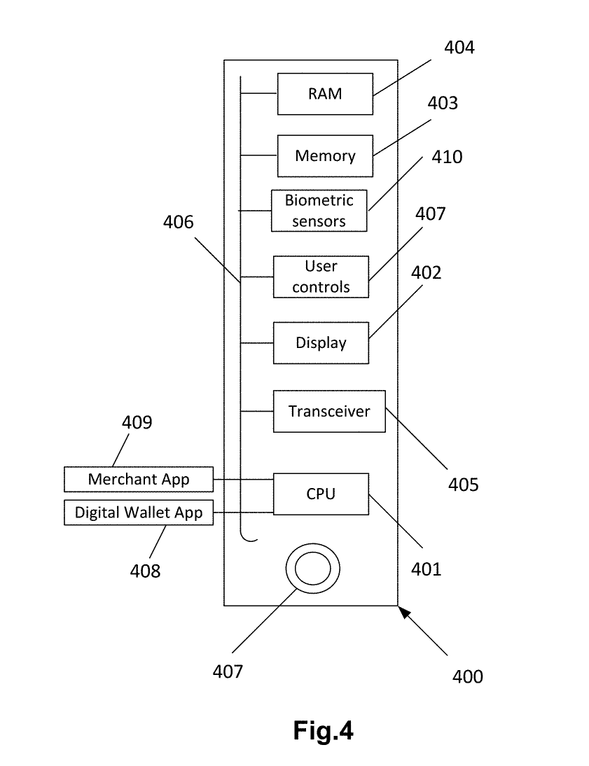

The user device 220 of any of the examples herein may be a handheld computer device such as a smart phone or a PDA such as one manufactured by Apple™, LG™, HTC™, Research In Motion™, Samsung™ or Motorola™. The user device 220 may include a mobile computer such as a tablet computer. Furthermore, the user device 220 may also include a wearable device like a smartwatch. An exemplary embodiment of a user device 400 is shown in FIG. 4. As shown, the device 400 includes the following components in electronic communication via a bus 406:
1. a display 402;
2. non-volatile memory 403;
3. random access memory (“RAM”) 404;
4. N processing components 401;
5. a transceiver component 405 that includes N transceivers;
6. biometric sensors 410; and
7. user controls 407.

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4.

The display 402 generally operates to provide a presentation of content to a user, and may be realized by any of a variety of displays (e.g., CRT, LCD, HDMI, micro-projector and OLED displays). And in general, the non-volatile memory 403 functions to store (e.g., persistently store) data and executable code including code that is associated with the functional components of a browser component and applications, and in one example, the payment application (digital wallet application) 408 and optionally a merchant application 409. In some embodiments, for example, the non-volatile memory 403 includes bootloader code, modem software, operating system code, file system code, and code to facilitate the implementation of one or more portions of the payment application 408 as well as other components well known to those of ordinary skill in the art that are not depicted for simplicity.

In many implementations, the non-volatile memory 403 is realized by flash memory (e.g., NAND or ONENAND memory), but it is certainly contemplated that other memory types may be utilized as well. Although it may be possible to execute the code from the non-volatile memory 403, the executable code in the non-volatile memory 603 is typically loaded into RAM 404 and executed by one or more of the N processing components 401.

The N processing components 401 in connection with RAM 404 generally operate to execute the instructions stored in non-volatile memory 403 to effectuate the functional components. As one of ordinarily skill in the art will appreciate, the N processing components 401 may include a video processor, modem processor, DSP, graphics processing unit (GPU), and other processing components.

The transceiver component 405 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The biometric sensors 410 include, for example, image capturing devices and microphones, whereby the biometric sensors 410 are configured to capture biometric information such as, for example, fingerprint data, iris data, facial features data, pulse rate data, voice data, retina data, ear cavity echo data, vein pattern data, speech pattern data and the like.

### Issuer Server 260 and Acquirer Server 270

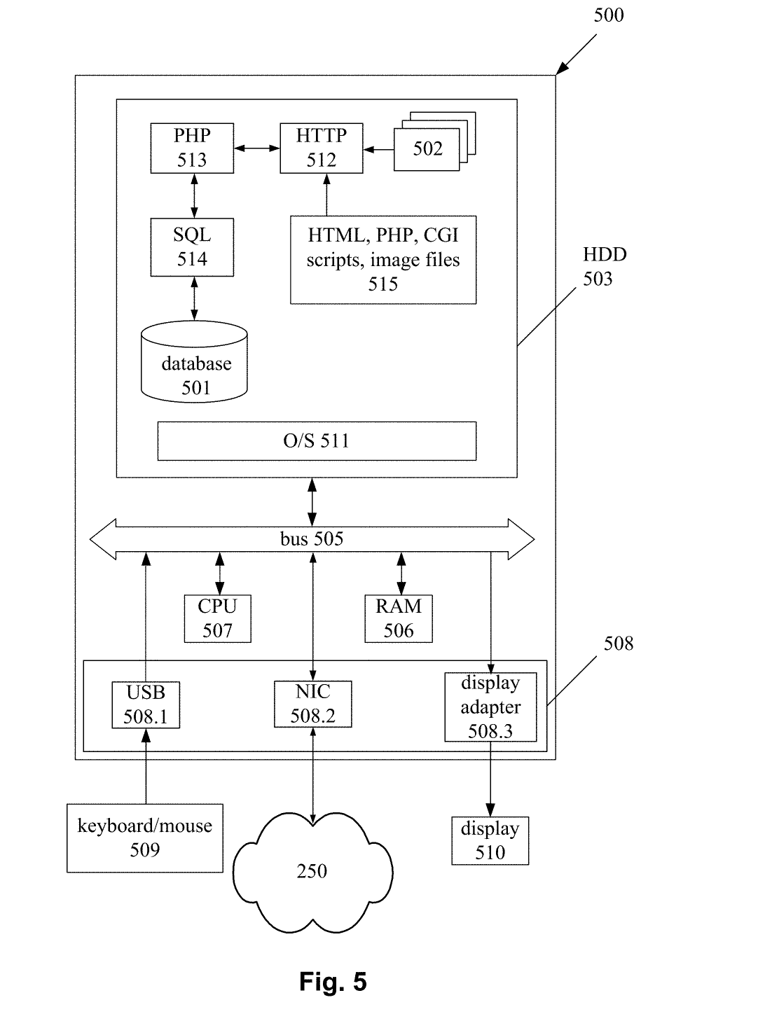

The issuer server 260 and the acquirer server 270 of any of the examples herein may be formed of any suitable processing device, and one such suitable device is shown in FIG. 5.

In this example, a processing device is provided by a server 500 in communication with a database 501, as shown in FIG. 5. The computer system 500 is able to communicate with the POS device 210, user device 220, the payment processing device 240, and/or other processing devices, as required, over a communications network 550 using standard communication protocols.

The components of the processing system 500 can be configured in a variety of ways. The components can be implemented entirely by software to be executed on standard computer server hardware, which may comprise one hardware unit or different computer hardware units distributed over various locations, some of which may require the communications network 550 for communication. A number of the components or parts thereof may also be implemented by application specific integrated circuits (ASICs) or field programmable gate arrays.

In the example shown in FIG. 5, the processing system 500 is a commercially available server computer system based on a 32 bit or a 54 bit Intel architecture, and the processes and/or methods executed or performed by the computer system 500 are implemented in the form of programming instructions of one or more software components or modules 502 stored on non-volatile (e.g., hard disk) computer-readable storage 503 associated with the computer system 500. At least parts of the software modules 502 could alternatively be implemented as one or more dedicated hardware components, such as application-specific integrated circuits (ASICs) and/or field programmable gate arrays (FPGAs).

The computer system 500 includes at least one or more of the following standard, commercially available, computer components, all interconnected by a bus 505:
1. random access memory (RAM) 506;
2. at least one computer processor 507, and
3. external computer interfaces 508:
   a. universal serial bus (USB) interfaces 508.1 (at least one of which is connected to one or more user-interface devices, such as a keyboard, a pointing device (e.g., a mouse 509 or touchpad),
   b. a network interface connector (NIC) 808.2 which connects the computer system 500 to a data communications network, such as the Internet 550; and
   c. a display adapter 508.3, which is connected to a display device 510 such as a liquid-crystal display (LCD) panel device.

The computer system 500 includes a plurality of standard software modules, including:
1. an operating system (OS) 511 (e.g., Linux or Microsoft Windows);
2. web server software 512 (e.g., Apache, available at http://www.apache.org);
3. scripting language modules 513 (e.g., personal home page or PHP, available at http://www.php.net, or Microsoft ASP); and
4. structured query language (SQL) modules 514 (e.g., MySQL, available from http://www.mysql.com), which allow data to be stored in and retrieved/accessed from an SQL database5.

Together, the web server 512, scripting language 513, and SQL modules 514 provide the computer system 500 with the general ability to allow users of the Internet 550 with standard computing devices equipped with standard web browser software to access the computer system 500 and in particular to provide data to and receive data from the database 501. It will be understood by those skilled in the art that the specific functionality provided by the system 500 to such users is provided by scripts accessible by the web server 512, including the one or more software modules 502 implementing the processes performed by the computer system 500, and also any other scripts and supporting data 515, including markup language (e.g., HTML, XML) scripts, PHP (or ASP), and/or CGI scripts, image files, style sheets, and the like.

The boundaries between the modules and components in the software modules 502 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the processes performed by the computer system 500 may be executed by a module (of software modules 502) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computer system 500 normally processes information according to a program (a list of internally stored instructions such as a particular application program and/or an operating system) and produces resultant output information via input/output (I/O) devices 508. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Payment System 240

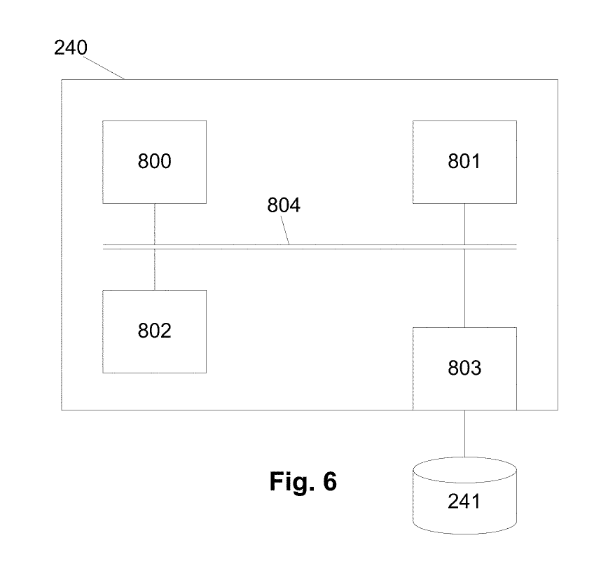

A suitable payment system 240 for use in the system described in any of the above examples is shown in FIG. 6.

In this example, the payment system 240 is a server (though in practice, the system 240 will comprise multiple such servers) that includes at least one microprocessor 800, a memory 801, an optional input/output device 802, such as a display, keyboard, touchscreen and the like, and an external interface 803, interconnected via a bus 804 as shown. In this example the external interface 803 can be utilised for connecting the payment server 240 to peripheral devices, such as the issuer server 260, the acquirer server 270, the communication networks 250, databases 241, other storage devices, or the like. Although a single external interface 803 is shown, this is for the purpose of example only, and in practice multiple interfaces using various methods (e.g. Ethernet, serial, USB, wireless or the like) may be provided.

In use, the microprocessor 800 executes instructions in the form of applications software stored in the memory 801 to allow communication with the primary service provider server 240, for example to process payment required at the primary service provider server 240. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the processing system is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer (in subsequent settlement and clearance processes as known in the art) who then deposits the payment into the merchant's account.

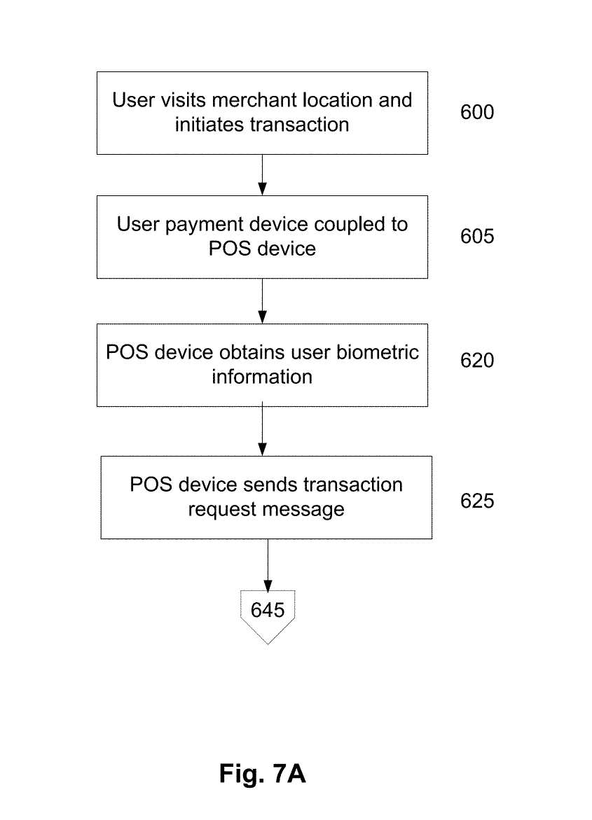

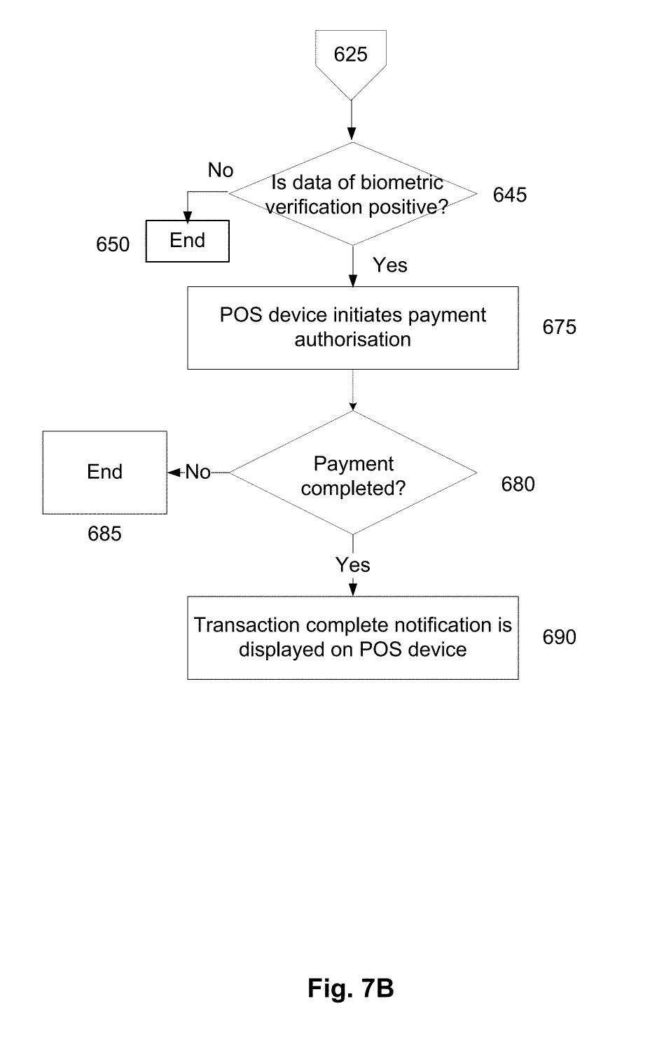

To illustrate further features of preferred practical implementations of the method, a first detailed example of a method of utilizing biometric data in a payment transaction will now be described with reference to FIGS. 7A-7B.

At step 600, a user visits a merchant location in order to perform a transaction involving the purchase of goods and/or services provided by the merchant. The merchant location may take any suitable form and may include for example a store or retail outlet, restaurant, bar or café or a train or bus station. The merchant location may be any location where a POS transaction is performed between a consumer and a merchant.

At step 605, a user payment device (for example, payment card or a user device) is coupled to a POS electronic processing device provided at the merchant location. Coupling can also be taken to mean pairing in appropriate circumstances. As previously described, any other suitable protocol (physical connection or wireless) may be used which allows communication between the POS device and the payment card or user device. Typically, the user will be able to connect or pair their device (such as a mobile phone, laptop, tablet, smartwatch etc.) to the POS device from anywhere within the premises at the merchant location, though in general, near-field communications (NFC) is preferred since it is more secure than longer-distance RF-based communications. In any event, it will also be appreciated from this that this step could occur before the transaction is performed, and reference to the particular order of steps is not intended to be limiting.

At step 620, the POS device can be configured to capture the user biometric information with requisite biometric sensors of the POS device. The user biometric information can include, for example, fingerprint data, iris data, facial features data, pulse rate data, voice data, retina data, ear cavity echo data, vein pattern data, speech pattern data and so forth. The user biometric information can be captured at a single juncture, over a pre-determined period of time, or in perpetuity. The POS device then sends a transaction request message including both the user account information and the user biometric information to an issuer server at step 625.

The user biometric information can comprise data indicative of whether a best available biometric information match was used in said at least one biometric verification method. The transaction request message can be an ISO 8583 formatted message and the user biometric information can be encoded in DE55 or DE48 when the transaction request message is an EMV transaction request message, or is encoded in track data when the transaction request message is a contactless magnetic stripe transaction request message.

At step 645, the issuer server assesses data indicative of results of at least one biometric verification process. It should be appreciated that a third party biometric verification server can also be used for the assessment of data indicative of results of at least one biometric verification process. If the assessment is negative, the transaction is refused at step 650. It should be appreciated that the assessment of the data is dependent on pre-determined thresholds as provided by a requisite entity.

Irrespective of the technique used, after a positive assessment, the POS device then initiates payment authorisation at step 675 in the standard manner that normal POS devices do as is well known in the art. In one example, the POS device sends the user account information and payment information to the merchant's acquirer. The acquirer then requests that the card network obtain an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

At step 680, the POS device determines whether payment was completed, and if not the process ends at step 685. Otherwise, an indication that the transaction was successful will be provided to the POS device from the issuer or acquirer. The POS device then displays a transaction complete notification to be displayed at step 690.

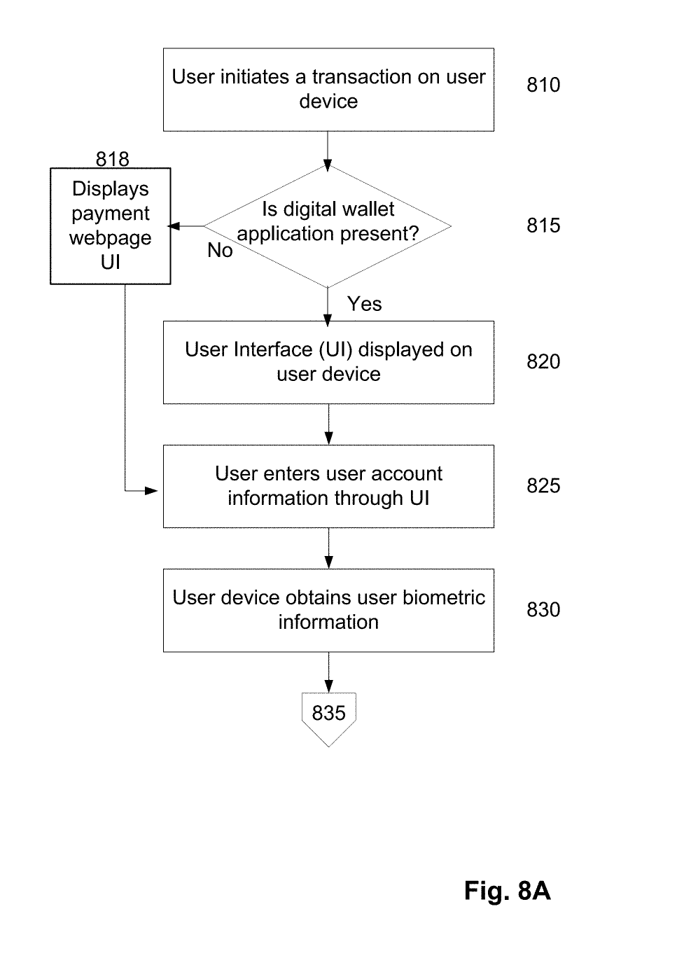

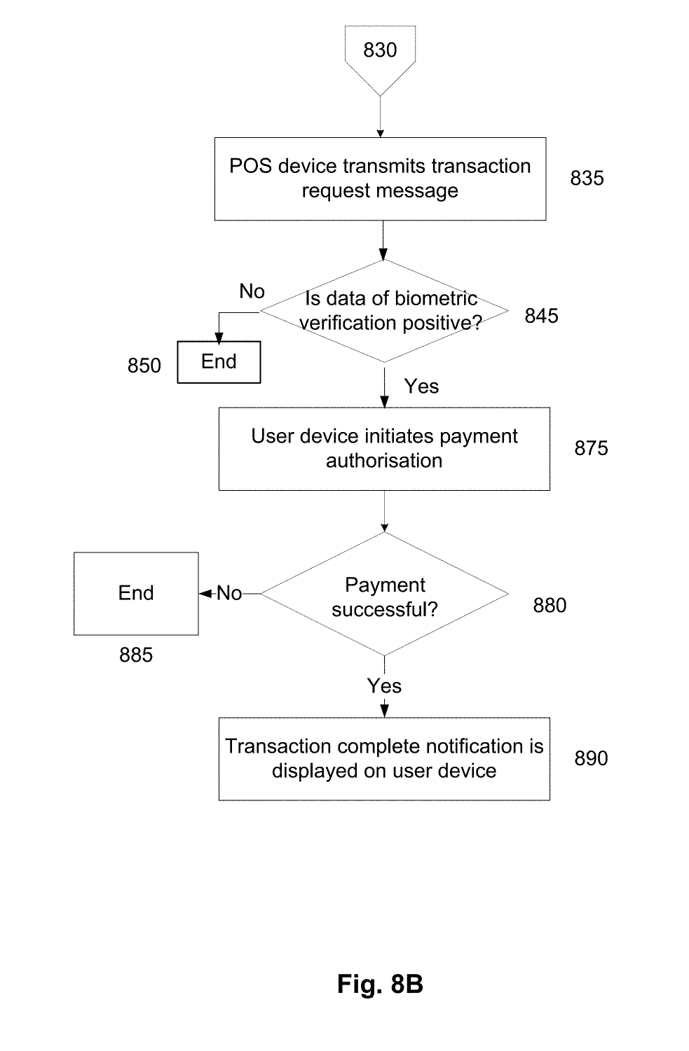

To illustrate further features of preferred practical implementations of the method, a first detailed example of a method of utilizing biometric data in a payment transaction will now be described with reference to FIGS. 8A-8B.

At step 810, a user desires to perform a transaction involving the purchase of goods and/or services provided by the merchant. The user need not be at a location of the merchant.

At step 815, the user device determines whether a digital wallet application (such as MasterPass™ by Mastercard™, or a digital wallet application of a bank or other issuer) is installed on the user device.

If it is determined that the user is registered to a digital wallet application, then at step 820, the user device displays payment information and the digital wallet application provides the account information to the POS device. In order for this to occur, the user device can rely on biometric verification to authenticate this request by providing verification information, with this being used by the digital wallet application to authenticate the user.

Thus, in one example, the user receives a message on their device notifying them that the user device has requested access to their digital wallet application and asking them to provide a PIN number to allow the POS device permission to access their personal account information. However, it will be appreciated that other verification information, such as biometric information or the like may be used. The account information may be stored locally on the user device or stored remotely on a wallet server (not shown) in communication with the digital wallet application. In this latter case, the PIN number will also typically be stored on the remote server such that when the user enters their PIN number, the user device determines whether verification is successful via communication with the digital wallet server. If the correct PIN is provided, the digital wallet server will provide an indication to the user device that the user verification was successful and in response, the user device will obtain the user account information from the digital wallet application.

Alternatively, if the user is not registered to a digital wallet application, at step 818, the user device displays a UI including the payment information, which is used to prompt the user to provide account information (such as credit or bank card details) through the user interface (such as a merchant shopping webpage).

In response to the presence of the digital wallet, the user device triggers a user interface (UI) to be displayed on the POS device at step 820. In one example, the user device displays a UI to the user that may for instance allow the user to enter a transaction request.

At step 825, the user enters user account information through the UI displayed on the user device.

At step 830, the user device can be configured to capture the user biometric information with requisite biometric sensors of the user device. The user biometric information can include, for example, fingerprint data, iris data, facial features data, pulse rate data, voice data, retina data, ear cavity echo data, vein pattern data, speech pattern data and so forth. The user biometric information can be captured at a single juncture, over a pre-determined period of time, or in perpetuity.

At step 835, the POS device then sends a transaction request message including both the user account information and the user biometric information to an issuer server at step 835. The user biometric information can comprise data indicative of whether a best available biometric information match was used in said at least one biometric verification method. The transaction request message can be an ISO 8583 formatted message and the user biometric information can be encoded in DE55 or DE48 when the transaction request message is an EMV transaction request message, or is encoded in track data when the transaction request message is a contactless magnetic stripe transaction request message.

At step 845, the issuer server assesses data indicative of results of at least one biometric verification process. It should be appreciated that a third party biometric verification server can also be used for the assessment of data indicative of results of at least one biometric verification process. If the assessment is negative, the transaction is refused at step 850. It should be appreciated that the assessment of the data is dependent on pre-determined thresholds as provided by a requisite entity.

Irrespective of the technique used, after a positive assessment, the user device then initiates payment authorisation at step 875 in the standard manner that digital wallet equipped user devices do as is well known in the art. In one example, the user device sends the user account information and payment information to the merchant's acquirer. The acquirer then requests that the card network obtain an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

At step 880, the user device determines whether payment was completed, and if not the process ends at step 885. Otherwise, an indication that the transaction was successful will be provided to the POS device from the issuer or acquirer. The POS device then displays a transaction complete notification to be displayed at step 890.

The present invention provides for the use of the user biometric information to aid in the approval of a transaction. For example, open operating systems like Android provides a framework for biometrics verification, but lack restrictions on false acceptance rate/false rejection rate/minimum expected matching score. In this regard, consumers are at risk as they rely on primarily vendor implementation/algorithm of biometric verification. The present invention provides a consistent level for biometric verification for consumers as it is administered by a single entity, and correspondingly, this consistency can assist in determining a risk score for consumers and the authorisation process (possibly reducing transaction declines) and the use of biometric verification can also aid in fraud detection/prevention.

In addition, by being provided with data indicative of results of at least one biometric verification process, such as the data mentioned in the examples above, as part of a transaction request message, the party responsible for approving or declining the transaction (typically, the issuer, or a delegate of the issuer such as a transaction processing service provider) is able to implement more nuanced risk management logic. For example, the risk management logic may be modified for a high-value transaction to take into account that the best available match was used such that a higher degree of confidence is associated with the transaction, so that the transaction can be approved when it might otherwise have been declined. This may help to reduce network traffic since there is a reduced rate of additional authorisation requests required following false declines. Additionally, since the biometric results data may be encoded in standard format transaction messages (such as ISO 8583 formatted messages), this additional information can be transmitted over standard payments infrastructure without significant modification to acquirer or issuer processing systems or to payment network servers.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1. A system for utilizing biometric data in a payment transaction, the system including one or more electronic devices that:
initiate, at a payment acceptance device, a transaction request;
request, from a user payment device and/or the payment acceptance device, user account information and user biometric information, the user biometric information including data relating to at least one biometric verification method;
generate, from the payment acceptance device, a transaction request message including the user account information and the user biometric information; and
initiate, at a payment processing system, payment authorization using the transaction request message.

2. The system of claim 1, wherein the payment acceptance device is a POS terminal.

3. The system of claim 1, wherein the user biometric information is obtained from the user payment device when coupled to the payment acceptance device, and/or at least one biometric sensor coupled to the payment acceptance device, wherein the user biometric information is verified at one or more of: the user payment device, the payment acceptance device, an issuer server and a third party verification server and, wherein the user biometric information captured by the payment acceptance device is captured at a single juncture, over a pre-determined period of time, or in perpetuity.

4. The system of claim 1, wherein a device certification rating of the user device is dependent on both a functionality and security assessment of the user device, and wherein the transaction request message is an ISO 8583 formatted message.

5. The system of claim 1, wherein the user biometric information comprises one or more selected from the group consisting of: fingerprint data, iris data, facial features data, pulse rate data, voice data, retina data, ear cavity echo data, vein pattern data and speech pattern data.

6. The system of claim 1, wherein the user biometric information comprises data indicative of whether a best available biometric information match was used in said at least one biometric verification method.

7. The system of claim 4, wherein the user biometric information is encoded in DE55 or DE48 when the transaction request message is an EMV transaction request message, or is encoded in track data when the transaction request message is a contactless magnetic stripe transaction request message.

8. A method for utilizing biometric data in a payment transaction, the method including, in one or more electronic processing devices:
initiating, at a payment acceptance device, a transaction request;
requesting, from a user payment device and/or the payment acceptance device, user account information and user biometric information, the user biometric information including data relating to at least one biometric verification method;
generating, from the payment acceptance device, a transaction request message including the user account information and the user biometric information; and
initiating, at a payment processing system, payment authorization using the transaction request message.

9. The method of claim 8, wherein the payment acceptance device is a POS terminal.

10. The method of claim 8, wherein the user biometric information is obtained from the user payment device when coupled to the payment acceptance device, and/or at least one biometric sensor coupled to the payment acceptance device, wherein the user biometric information is verified at one or more of: the user payment device, the payment acceptance device, an issuer server, and a third party verification server, and wherein the user biometric information captured by the payment acceptance device is captured at a single juncture, over a pre-determined period of time, or in perpetuity.

11. The method of claim 8, wherein a device certification rating of the user payment device is dependent on both a functionality and security assessment of the user payment device, and wherein the transaction request message is an ISO 8583 formatted message.

12. The method of claim 8, wherein the user biometric information comprises one or more selected from the group consisting of: fingerprint data, iris data, facial features data, pulse rate data, voice data, retina data, ear cavity echo data, vein pattern data and speech pattern data.

13. The method of claim 8, wherein the user biometric information comprises data indicative of whether a best available biometric information match was used in said at least one biometric verification method.

14. The method of claim 11, wherein the user biometric information is encoded in DE55 or DE48 when the transaction request message is an EMV transaction request message, or is encoded in track data when the transaction request message is a contactless magnetic stripe transaction request message.

15. A non-transitory computer readable storage medium embodying thereon a program of computer readable instructions which, when executed by one or more processors of a payment acceptance device in communication with at least one other server, cause the payment acceptance device to carry out a method for utilizing biometric data in a payment transaction, the method embodying the steps of:
initiating, a transaction request;
retrieving, user account information and user biometric information, the user biometric information including data relating to at least one biometric verification method; and
generating, a transaction request message including the user account information and the user biometric information;
wherein payment authorization is initiated using the transaction request message.

16. The storage medium of claim 15, wherein the payment acceptance device is a POS terminal.

17. The storage medium of claim 15, wherein the user biometric information is obtained from the user payment device when coupled to the payment acceptance device, and/or at least one biometric sensor coupled to the payment acceptance device, wherein the user biometric information is verified at one or more of: the user payment device, the payment acceptance device, an issuer server, and a third party server, and wherein the user biometric information captured by the payment acceptance device is captured either at a single juncture, over a pre-determined period of time, or in perpetuity.

18. The storage medium of claim 15, wherein a device certification rating of the user payment device is dependent on both a functionality and security assessment of the user payment device, and wherein the transaction request message is an ISO 8583 formatted message.

19. The storage medium of claim 15, wherein the user biometric information comprises one or more selected from the group consisting of: fingerprint data, iris data, facial features data, pulse rate data, voice data, retina data, ear cavity echo data, vein pattern data and speech pattern data.

20. The storage medium of claim 15, wherein the user biometric information comprises data indicative of whether a best available biometric information match was used in said at least one biometric verification method.

21. The storage medium of claim 18, wherein the user biometric information is encoded in DE55 or DE48 when the transaction request message is an EMV transaction request message, or is encoded in track data when the transaction request message is a contactless magnetic stripe transaction request message.
